(19) United States
(12) Patent Application Publication
(10) Pub. No.: US 2007/0250917 A1
(43) Pub. Date: Oct. 25, 2007

(54) Method and Device for the Remote Configuration of an Access Unit

(75) Inventors: Jorg Bruchertseifer, Augsburg (DE); Rainer Falk, Eching (DE)

Correspondence Address: BELL, BOYD & LLOYD, LLP, P.O. BOX 1135, CHICAGO, IL, 60690, US

(73) Assignee: Siemens Home and office Communication Devices Gmbh, Muenchen (DE)

(21) Appl. No.: 11/573,164

(22) PCT Filed: Jul. 18, 2005
(86) PCT No.: PCT/EP05/53440

§ 371 Date: Mar. 14, 2007

(30) Foreign Application Priority Data
Aug. 2, 2004 (DE) 10 2004 037 334.5

(51) Int. Cl. H04L 12/28; H04L 29/06

(52) U.S. Cl. 726/5

(57) ABSTRACT

A method for configuration of a data processing unit, in particular, a WLAN access point is disclosed. In order to prevent misuse of the data processing unit, activatable/deactivatable functions are automatically configured.

The present disclosure relates to a method for a data processing system and in particular for protecting the data processing system against unauthorized access.

### BACKGROUND

The present disclosure addresses the protection of data in the memory of a data processing system. Data which is transmitted by a data processing system or which is received by the data processing system is also to be protected. Digital encryption methods and passwords are suitable for protection. There are thus symmetrical encryption methods, e.g. AES (Advanced Encryption Standard), DES (Data Encryption Standard), IDEA (International Data Encryption Algorithm), RCA), and asymmetrical encryption methods, e.g. Diffie Hellman, RSA (Rivest, Shamir, Adleman), PGP (Pretty Good Privacy)). In the symmetrical encryption methods the same digital keys are used on the receiver side and on the transmitter side. By contrast, in the asymmetrical methods, keys which differ from each other are used on the receiver side and on the transmitter side.

Functions at risk of misuse are especially pertinent to:
The configuration itself, and
Accesses to public data transmission networks.

Basic settings are made by a user or by the manufacturer to the hardware and software of the data processing system during configuration.

### SUMMARY

Under an exemplary embodiment, a method is disclosed for configuring a data processing system which relieves the load on the user or administrator of performing configuration tasks and also offers a high level of security against misuse of the data processing system. In addition a data processing system is to be specified.

Under the exemplary embodiment, the following steps are executed, without any restriction being imposed by the sequence in which these steps are listed:
A data processing system is configured by defining the value of an item of configuration data that has a basic function or that is used for a basic function which goes beyond the configuration,
Depending on the item of configuration data, automatic configuration is performed on at least one function of the data processing system, whereby, if the automatically configured function is used, the basic function is not used, or whereby, if the automatically configured function is used, the basic function is used and a supplementary function is also provided which differs from the basic function.

The basic function is a function for which the configuration data was predetermined, by the user or automatically for example. For example, with a digital key the encryption with this digital key is the basic function. With a reference password the comparison with a password entered by the user is the basic function.

A function goes beyond the configuration if the item of configuration data is also used after the configuration, especially before the next configuration process. With automatic configuration a function is enabled or disabled, especially a function of the data processing system which is at risk of being misused. The automatic enabling or disabling is part of the configuration if this involves modifying at least one value of an item of configuration data in the memory of the data processing system. The automatic enabling or disabling is however also part of the configuration if, each time the automatically configured function is called, a check of the item of configuration data is executed for the basic function and then, depending on the result of the check, the function call is aborted or the automatically configured function is executed.

Under an alternate embodiment, the basic function is not used within the framework of the automatic function. Despite this, the basic function or the item of configuration data associated therewith is suitable, because of the absence of the other data, for use as a basis for the automatic configuration, e.g. as a measure for security precautions. With a WLAN access point in particular, remote administration from the Internet depending on the encryption on a wireless transmission link in the WLAN (Wireless Local Area Network) can be configured. The administration from the Internet is only permitted if an encryption is activated or secured on the wireless transmission link. With the actual administration from the Internet however the encryption on the wireless transmission link is not used because an access unit of the wireless network is reached via a wired link.

With the second alternative, to provide the automatically configurable function, the configuration data or the basic function associated with this configuration data is used, so that the configuration data is therefore especially suitable as a measure for the presence of security when the automatically configured function is provided.

This means that, with the inventive method, an additional function which a user does not have to know anything about is assigned to an item of configuration data. Depending on the value of the item of configuration data, a configuration for another function is also executed. The method is able to be used both for configuration of hardware and also for the configuration of software.

In a further embodiment the following steps are executed:
Storing a test specification in the data processing system, with the test specification relating to the item of configuration data,
Reading the value of the item of configuration data and testing the value in accordance with the test specification,
Depending on the result of the test, executing the automatic configuration.

The test specification contains a setpoint value for the item of configuration data for example. Compliance with the setpoint value is checked in accordance with the test specification. The test specification contains a condition for the value of the configuration data, for example. Syntax checking or another type of checking is also possible. The test specification is typically stored in the data processing system as a data record or as a test process, e.g. in the commands of a program.

In another embodiment, the test specification relates to compliance with at least one predetermined security condition which renders it more difficult to misuse the data processing system. For example two, three or more than three conditions are predetermined. Also the basic function may relate to the protection of the data processing system against unauthorized access. Furthermore, the automatically configured function, or the additional function, may be a function which is at risk of misuse. A method is described below that establishes an especially high level of protection against misuse of the data processing system.

At least two items of configuration data are included in the automatic configuration of the function, i.e. of a single function. The inclusion of a number of items of configuration data allows especially high levels of security to be predetermined in a simple manner. In one embodiment, the further item of configuration data also has a basic function which goes beyond the configuration.

The item of configuration data is preferably a reference password used for comparison with a user password. On automatic configuration it is established for example that no reference password has been set or that a start reference password has been set or that the reference password is not secure. Therefore the automatically configured function or the additional function can be disabled or restricted in its functionality. If on the other hand, if it is established checking testing that a reference password has been set or that no start reference password has been set or that the reference password is secure, the function at risk of misuse or the automatically configured function are enabled. In particular the inclusion of a number of the three given test criteria provides a high level of protection.

A reference password serves as a basis for a comparison of a password which must be entered by the user of the data processing system during operation. A start reference password is predetermined automatically by the manufacturer or when the data processing system is reset to its default values, especially always in the same manner or to the same value. This means that a start reference password makes misuse easier, since it can be taken from the documentation that the manufacturer supplies with a data processing system for example. The following checks in particular are made during automatic configuration:
The length of the password, and
Avoidance of trivial passwords, such as alf, 1111 etc.

Also, the item of configuration data may be a digital key that is used in an encryption method. In automatic configuration it may be established, for example, that no digital key has been set or that a start key has been set or that the key is not secure. Therefore the function at risk of misuse, or an automatically configured function is disabled or restricted in its functionality. If by contrast it is established during checking that a digital key has been set or that no start key has been set or that the key is secure, the function at risk of misuse will therefore be enabled. In particular two or three of the specified checking steps are executed to increase the security.

The digital key is used for encryption of data according to an encryption method, e.g. a symmetrical or unsymmetrical method, e.g. PGP (Pretty Good Privacy). A start key is predetermined by the manufacturer or is always created in the same way during an automatic configuration. This means that the key is especially not suitable as a private digital key.

A configuration validation function also checks especially:

Is the security function activated at all?

Do the key material entered or the password entered or the passphrase entered satisfy specific criteria, especially syntactical criteria? Examples of such criteria are: Length, occurrence of special characters or digits, uppercase and lowercase letters; avoidance of trivial or of weak passwords/keys stored in a database (examples: 1111, 9999, 1234, tsunami, home, Siemens, secret).

Have initial security parameters, i.e. those predetermined by the device manufacturer or reset to their initial values after a “full reset”, changed (e.g. default password, default key)?

The automatically configurable function or the additional function may also relate to:
A remote access to an administration function of the (communication) device (e.g. via Web browser (HTTP) or Telnet) via a wireless interface or from a public network (Internet),
Access from the communication device to services of a public network (Internet, telephone network),
The availability of usable communication-protocols, where the communication device, for example, filters out protocols which transmit passwords in plain text, or in which weak, easily breakable security methods are used, e.g. POP3 (Post Office Protocol), IMAP (Internet Mail Access Protocol), SMTP (Simple Mail Transfer Protocol), SNMP (Simple Network Management Protocol), FTP (File Transfer Protocol), TFTP (Trivial File Transfer Protocol). The filtering can be undertaken especially on the basis of the TCP/UDP (Transmission Control Protocol/User Datagram Protocol) port number (packet filter). Filtering means that communication using the protocols involved is suppressed, i.e. that the packets belonging to these protocols are not processed or forwarded.

In yet another embodiment, the data processing system may be an access point for a wireless transmission network, such as a WLAN (Wireless Local Area Network), where the radio transmission network operates in accordance with at least one of the following IEEE (Institute of Electrical and Electronics Engineers) Standards: 802.11, 802.11a to 802.11i etc. In another embodiment, the radio transmission network may operate in accordance with the Bluetooth or HomeRF (Home Radio Frequency) Standards. Wireless transmission networks, and especially WLANs, are particularly at risk because of their spatially extended wireless interface, so that the methods disclosed herein can be employed to especially great effect. It is especially made possible for private users to enable their WLAN to meet a high standard of security against misuse right from the start. Alternately, the data processing system is a control for an industrial system for a machine tool or for another machine with remote control.

The present disclosure also relates to data processing system. The data processing system is especially suitable for the executing the method as claimed in the invention or one of its developments, so that the technical effects specified above also apply to the data processing system.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 illustrates a WLAN access unit and a portable data processing unit under an exemplary embodiment,

FIG. 2 illustrates functional units of the access unit of FIG. 1, and

FIG. 3 illustrates method steps which are executed during the operation of the access unit.

### DETAILED DESCRIPTION

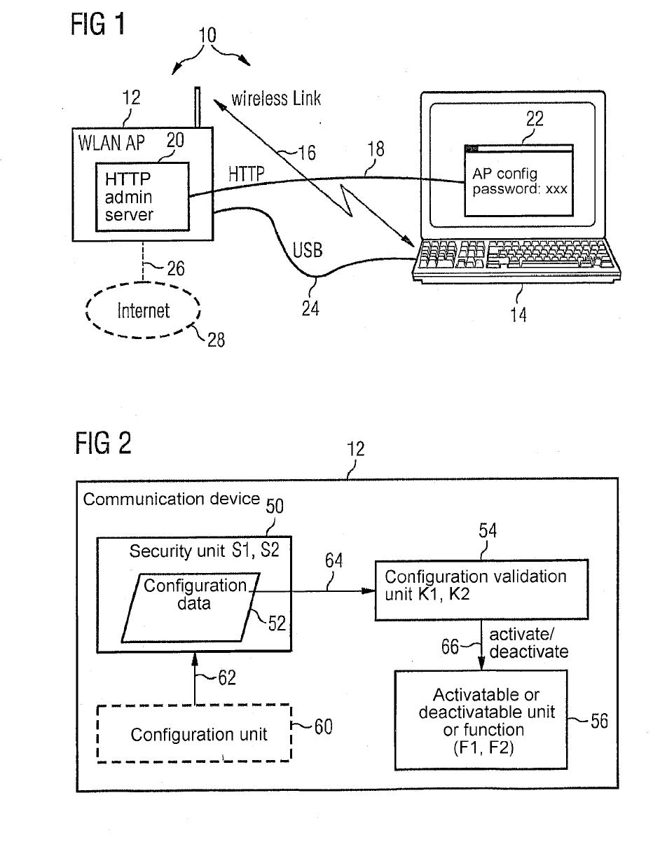

FIG. 1 illustrates an exemplary WLAN 10, where WLAN 10 contains a WLAN access point 12. The access point 12 has an administration service provision program 20, which possesses functionality for remote administration, using a wireless transmission link 16 (WLAN) and a Browser 22. In the exemplary embodiment the Browser 22 is located on a portable data processing system 14, also referred to as a notebook. Alternately, instead of the data processing system 14, a personal computer can also be used for example.

The data processing system 14 can communicate with the access unit 12 via the radio transmission link 16 or via a USB (Universal Serial Bus) cable. The access point 12 can be configured via Web browser 22 or another browser program, which communicate for example using the HTTP (Hypertext Transfer Protocol) with the administration service provision program 20 (HTTP Admin Server) on the access point 12. Not shown in the diagram are further PCs (Personal Computers) or an Internet gateway (e.g. DSL (Digital Subscriber Line) modem) in the Internet 28 accessible via an Internet connection 26. Furthermore HTTPS (Secure HTTP) can also be used instead of HTTP, i.e. HTTP over SSL/TLS (Secure Socket Layer/Transport Layer Security). Furthermore, instead of USB, a serial port, e.g. in accordance with RS-232 can be used.

The embodiment is implemented in the access point 12 containing a processor and a command memory (not shown in the diagram), in which program commands are stored, during the execution of which by the processor the steps explained below are executed.

The access point 12 for example has two configurable security functions S1 and S2:
S1) Administration password D1, and
S2) Encryption of the wireless transmission link with the aid of WEP (Wired Equivalent Privacy), WPA (Wi-Fi Protected Access, with Wi-Fi referring to the Wi-Fi Alliance) or WPA2, whereby the key D2 is used.

The access point 12 typically has two activatable or deactivatable functions:
F1) Remote administration via HTTP over the wireless transmission link 16, and
F2) Remote administration via HTTPS over the wireless transmission link 16.

As shown in FIG. 2, the access unit 12 also has a configuration code validation unit 54 or validation function which checks the following (criteria (K1) and (K2)):
K1): Administration password D1 set from S1, minimum length complied with,
K2): activated feature S2, key D2 set and not initial key D2.

The activatable or deactivatable functions F1 and F2 are now activated or deactivated as detailed below, independently of the result of the configuration validation
Activate F1 if K1 and K2 are fulfilled, else deactivate F1,
Activate F2 if K1 is fulfilled, else deactivate F2.

Administration via the direct USB-connection by means of USB cable 24 is always possible in the exemplary embodiment regardless of whether K1 and/or K2 are fulfilled or not. With administration via USB cable querying the administration password is optional, i.e. it is used or it is not used. However with remote administration via another data transmission network, e.g. wireless transmission link 16 or Internet connection 26, the administration password D1 is queried.

FIG. 2 shows functional units of the access unit 12. A security unit provides the basic functions S1 or S2. The configurable security function S1 and S2 especially involve:
S1) Protection for remote administration access to the communication device 12 by issuing an administration password D1 or issuing an administrations-password D1 which fulfills specific minimum criteria (syntactical criteria),
S2) Protecting a wireless interface 16 by activating data encryption for the radio interface (WEP or WPA for WLAN); security material entered (digital key D2, password) fulfills specific minimum criteria.

The security unit 50 contains a memory unit 52, in which the password D1 and the key D2 are stored. A configuration validation unit 54 is used for automatic configuration of the activatable or deactivatable functions F1 and F2. For this the validation unit 54 reads the password D1 and the key D2 out of the memory unit 52, see arrow 64. The checking criteria K1 and K2 which are checked using the password D1 or the key D2 are stored in the validation unit 54.

An activatable or deactivatable unit 56 for providing the function F1 or F2 is activated or deactivated by the validation unit 54 depending on the check result, see arrow 66.

The password D1 and the key D2 are predetermined directly with a configuration unit 60, see arrow 60. Especially through a manual configuration or through an automatic configuration during a setup.

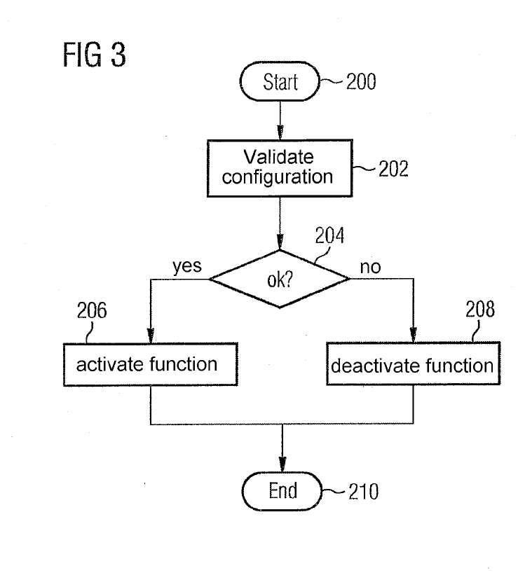

FIG. 3 shows method steps executed during operation of the access point 12, especially when the access point 12 is started. The method begins at step 200. In a method step 202, following method step 200, the validation unit 54 automatically executes the validation for the checking criteria K1 and K2 depending on the password D1 or the key D2. The results of the checks for the criteria K1 and K2 are stored.

In method step 204 a check is made as to whether the two criteria K1 and K2 are fulfilled. If they are, method step 204 is followed directly by method step 206. In method step 206 the function F1 is enabled, for example by storing a further item of configuration data, for which the value is queried before the function F1 is used. This means that remote administration over the wireless transmission link 16 by means of HTTP is possible.

If on the other hand it is established in method step 204 that only one criterion K1, K2 or no criteria K1, K2 is or are fulfilled, method step 204 is followed directly by method step 208 in which the function F1 is disabled, so that no remote administration via the wireless link 16 by means HTTP is possible.

After method step 206 or method step 208, the automatic configuration of function F1 is ended in a method step 210.

A second pass of method steps 200 to 210 is executed in order to enable or disable the function F2. In this pass only the checking criterion K1 is checked in method step 204, with for example the result for the checking criterion K1 being used which has already been determined in the first pass, so that step 202 is optional in the second pass. Alternately the checking criterion K1 is checked once more.

In another exemplary embodiment administration over the Internet 28 is allowed if a secure administration password D1 has been defined. Administration over the Internet 28 is disabled if no secure administration password D1 has been defined. An administration password D1 is secure if it cannot be easily guessed. For example it can be required to have a minimum length, to contain at least one digit or special character, or to be different from a start password or an example password used in the documentation. With a non-secure administration password D1 administration over the Internet 28 is prevented, even if the correct administration password D1 is used. Administration is possible on the other hand over a wireless link 16 with the administration password D1.

The exemplary embodiment can also be applied to a system control (industrial control) which has the option of remote administration. If a security function for securing remote administration was not activated or if only weak security material was entered, no remote administration is possible. In the meantime the system control can only be administered locally, for example via a built-in administration function or a built-in user interface or via a directly connected administration device (PC/notebook, via USB or serial port).

The security functions of a communication device (especially WLAN access point, Internet gateway) or of another device can be correctly configured in this way for secure and reliable operation. Configuring such security functions comprises setting passwords, cryptographic keys, certificates and access policies for administrative access to the communication device (administration password) as well as for protection of wireless connections (e.g. WEP key or PSK key (Pre Shared Key) for WLAN devices with Wi-Fi Protected Access WPA).

The device is equipped with functionality which could be misused by malicious attackers if security functions were missing or inadequately configured, if the inventive method is not used and the administrator has too little specialist knowledge. This includes for example the modification of the device configuration, the reading out of statistical or log data of the use of chargeable resources such as Internet access and access to the telephone network (POTS (Plain Old Telecommunication system), ISDN (Integrated Services digital Network)).

In a consumer environment in particular there is the problem of devices being able to be configured by end users who have no knowledge or insufficient specialist knowledge of security. This can result in security functions not being configured, e.g. no administration password being set, encryption of a wireless connection not being activated and initial passwords/keys not being changed, or in weak, trivial passwords or keys being issued (for example “abc”, “12345”, or passwords/keys specified in the documentation as examples).

These can provide opportunity for attack against the communication device and thereby against its user if the methods disclosed herein are not used, which effectively increase the level of security for a device with configurable security functions.

In summary it can be said that the present disclosure provides a (communication) device with at least one activatable and deactivatable functionality, at least one configurable security function as well as a configuration validation function, with this configuration validation function validating the configuration of the at least one configurable security function, and depending on the result of this validation, the at least one activatable or deactivatable functionality being activated or deactivated.

The device concerned may be a communication device (access point), an (Internet) gateway, router, switch, modem, hub, mobile telephone, cordless telephone, telephone system or combination of these), a computer (PC (Personal Computer), workstation, PDA (Personal Digital Assistant)), or a control device (e.g. system control with remote maintenance access) with a radio interface, or another, potentially insecure interface for remote administration.

The disclosed configuration significantly increases the security level achievable in practical operation, since potentially dangerous functionality can only be used if the required security functions are configured or if they are configured in such a way that a minimum security level is reached.

The present methods are especially suitable for environments in which end users must configure a communication device themselves, without however necessarily possessing the actual security knowledge required for this. There effectively prevent a user accidentally activating and using potentially dangerous functionality without having configured the security functions required.

Remote administration of a communication device over an Internet connection, or a wireless connection, if a strong administration password has been issued, and/or if data encryption of the wireless interface is activated can be achieved. Users do not have to deactivate remote administration themselves, it is forcibly deactivated instead if it is not sufficiently secured or until such time as it can be insured that other basic security precautions have been taken.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1-12. (canceled)

13. A method for configuring a data processing system, comprising the steps of:
configuring a data processing system by defining the value of an item of configuration data which has a basic function or is used for a basic function which goes beyond the configuration;
automatically configuration of at least one function of the data processing system depending on the item of configuration data; and
not applying the basic function, if the automatically configured function is used, and applying the basic function if the automatically configured function is used, and in addition there is a supplementary function which differs from the basic function.

14. The method as claimed in claim 13, further comprising:
storing a test specification in the data processing system with the test specification relating to the item of configuration data;
reading the value of the item of configuration data; and
checking the value in accordance with the test specification depending on the result of the check executing the automatic configuration.

15. The method as claimed in claim 14, wherein the test specification relates to compliance with at least one predetermined security condition and that the basic function relates to protecting the data processing system against unauthorized access, and that the supplementary function is a function at risk of misuse.

16. The method as claimed in claim 13, wherein the configuration data is included in the automatic configuration of the function.

17. The method as claimed in claim 13, wherein a portion of the configuration is a reference password which is used for a comparison with a password entered by the user.

18. The method as claimed in claim 17, wherein the automatic configuration establishes at least one of the following:
that no reference password has been set;
that a start reference password has been set;
that the reference password is not stored and that therefore the automatically configured function is disabled or is restricted in its functionality;
that a reference password has been set,
that no start reference password has been set;
that the reference password is stored and that therefore the automatically configured function is enabled.

19. The method as claimed in claim 13, wherein a portion of configuration data is a digital key which is used in an encryption method.

20. The method as claimed in claim 19, wherein the automatic configuration establishes at least one of the following:
that no digital key has been set,
that a start key has been set,
that the key has not been stored and that therefore the automatically configured function is disabled or is restricted in its functionality,
that a digital key has been set;
that no start key has been set;
that the key is stored and that therefore the automatically configured function is enabled.

21. The method as claimed in claim 13, wherein the automatically configured function relates to:
a remote access to an administration function, or
an access by the data processing system to services of a public data transmission network, or
usable communication protocols.

22. The method as claimed in claim 13, wherein the data processing system is one of an access point to a wireless transmission network and a control for a machine.

23. A data processing system, comprising:
a configuration unit, with the aid of which the data processing system is configured by defining at least one value for at least one item of configuration data that has a basic function or is used for a basic function which goes beyond the configuration;
an automatic configuration unit, which makes checks in accordance with a test specification relating to the item of configuration data; and
an enabling/disabling unit, of which the input is connected to the output of the automatic configuration unit and which, depending on the result of the checking, enables or disables the automatically configured function with the basic function not being used if the automatically configured function is used or the basic function being used if the automatic configuration function is used and in addition a supplementary function is provided which differs from the basic function.
